(19) United States
(12) Patent Application Publication
(10) Pub. No.: US 2020/0140721 A1
(43) Pub. Date: May 7, 2020

(54) Tape Having Alternating Non-Adhesive Portions

(71) Applicant: Pati Ann Gross, Pinellas Park, FL (US)

(72) Inventor: Pati Ann Gross, Pinellas Park, FL (US)

(21) Appl. No.: 16/182,900

(22) Filed: Nov. 7, 2018

(51) Int. Cl. C09J 7/20

(52) U.S. Cl. CPC C09J 7/201; C09J 2201/20

(57) ABSTRACT

Tape being a length of material having a nonadhesive track traversing the length of the material. The nonadhesive track is oriented between two adhesive portions. The nonadhesive track can have a first end connected to a nonadhesive radial portion configured to receive a finger of a user. The nonadhesive track can have a second end connected to a perforated leading edge of the length of material.

### BACKGROUND OF THE INVENTION

### 1. Field of the Invention

This invention relates, generally, to tape. More particularly, it relates to tape having alternating non-adhesive portions that are configured to be easily grasped by a user to facilitate the peeling away of the tape from an object or from itself.

### 2. Background Art

Tape is a length of material having an adhesive side used for attachment purposes. Tape includes, but is not limited to, adhesive tape, packaging tape, office tape, duct tape, painters tape, transparent tape, or medical tape. Current tape in today's market has an adhesive side that completely adheres to not only the tape roll during storage, but for example, to an object during packaging. As a result, during the packaging process, it may be difficult for a user to locate and to begin unpeeling the end of the tape from the tape roll because current rolls of tape are completely adhered to each subsequent layer of tape in the roll. Additionally, during the unpackaging process it may be difficult for a user to locate and to begin unpeeling the leading end of the tape from a package because of this complete adherence. It would be more desirable for a user to be able to easily insert their finger or finger nail under a nonadhesive portion of tape that was not adhered to the other layers of tape in a roll of packaging tape for example. Thus, there is a need for a tape having a partial adhesive side including, but not limited to, alternating adhesive and nonadhesive portions traversing the length of the tape.

However, in view of the prior art considered as a whole at the time the present invention was made, it was not obvious to those of ordinary skill in the pertinent art how the identified needs could be fulfilled.

### SUMMARY OF THE INVENTION

The long-standing but heretofore unfulfilled need for tape being a length of material having a nonadhesive track traversing the length of material. The nonadhesive track is oriented between two adhesive portions. The nonadhesive track can have a first end connected to a nonadhesive radial finger grip configured to receive a finger or a finger nail of a user. The nonadhesive track can have a second end connected to a perforated leading edge of the length of material.

The invention includes tape having a nonadhesive portion. An important aspect of this invention is the fact that the nonadhesive track traverses the entire length of material so that at least a portion of the nonadhesive track is exposed on a second subsequent length of material even after a first length of material is detached or cut from a subsequent second length of material. The tape is a length of material having a first side located opposite a second side. The second side of the length of material has a nonadhesive track. The nonadhesive track has a first edge located opposite a second edge. The nonadhesive track has a first end located opposite a second end. The nonadhesive track traverses the length of material. The second side of the length of material has a first adhesive portion abutting the first edge of the nonadhesive track. The second side of the length of material has a second adhesive portion abutting the second edge of the nonadhesive track.

In a preferred embodiment, the novel tape is a length of material formed on a roll. Alternatively, it is within the scope of this invention for the novel tape with a partial adhesive portion to be formed as layered sheets or an individual length of material.

In another embodiment, the novel tape has a first edge of the nonadhesive track and the second edge of the nonadhesive track traversing the length of material.

In another embodiment, the novel tape is a length of material having a nonadhesive radial finger grip configured to receive a finger or finger nail of a user. The nonadhesive radial portion has a first radial edge bordering the first adhesive portion of the length of material. The nonadhesive radial finger grip has a second radial edge bordering the second adhesive portion of the length of material. The first end of the nonadhesive track is connected to the nonadhesive radial finger grip.

In another embodiment, the novel tape has at least a portion of the nonadhesive radial finger grip configured to abut a first perforated leading edge of the length of material. The nonadhesive radial finger grip is located between the first perforated leading edge and the nonadhesive track of the length of material.

In yet another embodiment, the novel tape has a first perforated leading edge of the length of material being oriented perpendicular to the nonadhesive track.

In another embodiment, the novel tape has a second end of the nonadhesive track connected to a second perforated leading edge of the length of material. The nonadhesive track is oriented between the first perforated leading edge of the length of material and the second perforated leading edge of the length of material.

In an alternate embodiment, the novel tape is a length of material having a series of perforations oriented perpendicular to the nonadhesive track. The nonadhesive track is oriented between the first perforated leading edge of the length of material and the second perforated leading edge of the length of material.

In another embodiment, the novel tape has at least a portion of the nonadhesive radial finger grip abutting a first surface indicia of the length of material. It is within the scope of this invention for surface indicia to include, but not be limited to, any visible marking, line, dash, ruler measurement markings, or color indicators that indicate to a user where the optimal location is to tear the tape for proper alignment of the subsequent nonadhesive radial finger grip. The first surface indicia and the second surface indicia are predetermined indicators configured to indicate to a user the portion of the length of material at which a user should cut the tape in order to align and access a subsequent nonadhesive radial finger grip for future or subsequent use. The nonadhesive radial finger grip is located between the first indicia of the length of material and the nonadhesive track. The second end of the nonadhesive track is connected to a second surface indicia of the length of material. The nonadhesive track is oriented between a first surface indicia of the length of material and a second surface indicia of the length of material.

### BRIEF DESCRIPTION OF THE DRAWINGS

For a fuller understanding of the nature and objects of the invention, reference should be made to the following detailed description, taken in connection with the accompanying drawings, in which:

FIG. 1 is a rear perspective view of the second side of the novel tape being a length of material with alternating nonadhesive tracks and adhesive portions;

FIG. 2 is a rear perspective view of an alternate embodiment of the second side of the novel tape being a length of material with perforations and a nonadhesive radial finger grip connected to the nonadhesive track;

FIG. 3 is a rear perspective view of an alternate embodiment of the second side of the novel tape on a roll being a length of material with surface indicia and a nonadhesive radial finger grip connected to the nonadhesive track; and,

FIG. 4 is a top perspective view of the novel transparent tape on a roll being a length of material with perforations and a nonadhesive radial finger grip connected to a nonadhesive track traversing the length of material.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

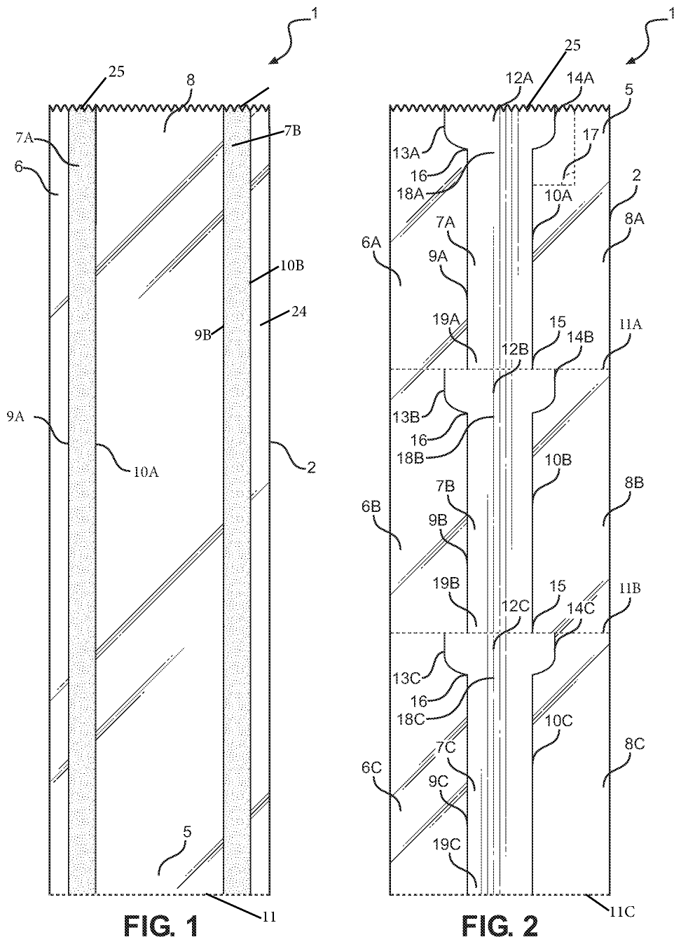

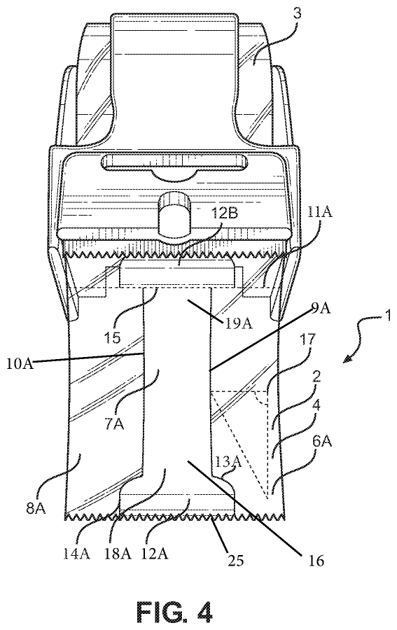

In a general embodiment as depicted in FIG. 1, novel tape 1 has length of material 2. Length of material 2 has first side 4 (FIG. 4) located opposite second side 5 (FIGS. 1, 2, and 3). At least a portion of tape 1 has a partial adhesive portion traversing the entire length of material. It is within the scope of this invention for the length of material to include, but not be limited to, a cloth tape coated with a poly-ethylene resin on one side and a sticky rubber-based adhesive on the other or a cellophane tape having a backing to which an adhesive substance is affixed for the purpose of joining materials with a surface bond. A film of cellulose may provide the backing for adherence made from chemically treated petroleum byproducts that create the tape's stickiness. Novel tape 1 can have at least one nonadhesive portion. It is within the scope of this invention for the nonadhesive portion to be a first nonadhesive track 7A. Nonadhesive track 7A can extend the entire length of material 2. Nonadhesive track 7A has first edge 9A located next to first adhesive portion 6. Nonadhesive track 7A has second edge 10A located next to second adhesive portion 8. An important feature of novel tape 1 is that the nonadhesive track 7A is oriented between first adhesive portion 6 and second adhesive portion 8. A user accesses at least a portion of nonadhesive track 7A at a location of leading edge 25 of the initial piece of length of material 2 or leading edge 11 once length of material 2 is cut. Length of material 2 may be cut anywhere along length of material 2 to expose at least a portion of nonadhesive track 7A.

FIG. 1 further illustrates novel tape 1 having a second nonadhesive track 7B. It is envisioned that at least one nonadhesive track or a plurality of nonadhesive tracks 7A and 7B are located on length of material 2. Second nonadhesive track 7B has first edge 9B of second nonadhesive track 7B located next to second adhesive portion 8. Second nonadhesive track 7B has second edge 10B of second nonadhesive track 7B located next to third adhesive portion 24. When tape 1 is on a roll, on a sheet, or already applied to an item, it is an aspect of this invention for a user to be able to access with their finger at least a portion of at least one non adhesive track 7 at a leading edge 25 (FIGS. 1-4) of tape 1. At least a portion of at least one nonadhesive track 7 is accessible to a user's finger or finger nail at perforated leading edge 11 when detached from a roll and applied to a package, for example. In this embodiment, first nonadhesive track 7A is oriented parallel to second nonadhesive track 7B.

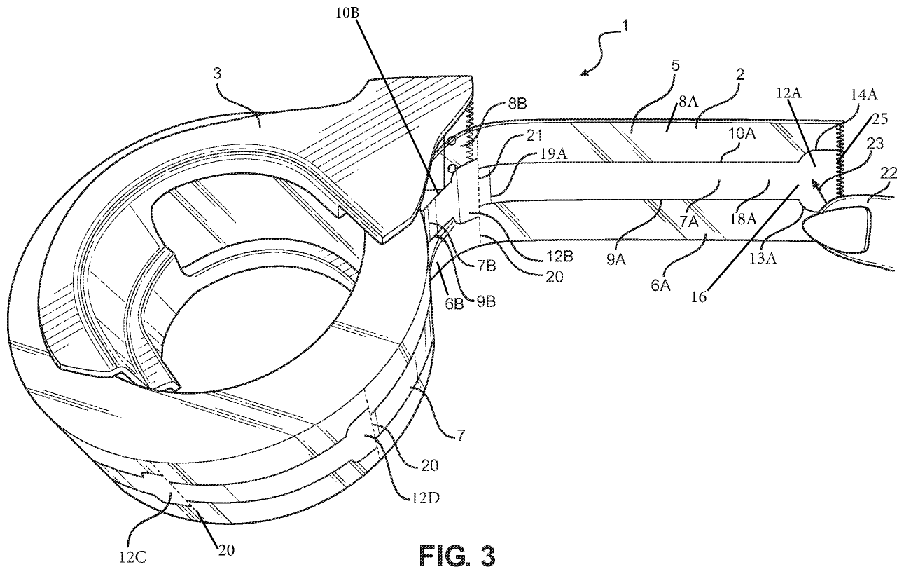

FIGS. 2-4 illustrate an alternate embodiment of novel tape 1 having length of material 2 in which first portion of nonadhesive track 7A has nonadhesive radial finger grip 12A. Nonadhesive radial finger grip 12A is configured for a user's finger 22 (FIG. 3) or finger nail to grip or to connect to 23 (FIG. 3) while removing length of material 2 from including, but not limited to, a roll (FIGS. 3-4), a sheet, a package, or an item. First portion of nonadhesive track 7A has first edge 9A located next to first adhesive portion 6A. First portion of nonadhesive track 7A has second edge 10A located next to second adhesive portion 8A. First portion of nonadhesive track 7A has primary end 18A located opposite secondary end 19A. First portion of nonadhesive track 7A is connected to 16 nonadhesive radial finger grip 12A at primary end 18A of first portion of nonadhesive track 7A. Nonadhesive radial finger grip 12A has first radial edge 13A bordering at least a portion of first adhesive portion 6A. Nonadhesive radial finger grip 12A has second radial edge 14A bordering at least a portion of second adhesive portion 8A. Leading edge 25 of length of material 2 is oriented perpendicular 17 (FIGS. 2 and 4) to nonadhesive track 7A.

FIG. 2 also shows length of material 2 having perforated edges 11A, 11B, and 11C. At least one perforated edge or a plurality of perforations can be oriented at a predetermined length along length of material 2. Perforated edge 11 allows length of material 2 to be torn or separated from a subsequent portion of length of material 2 without the need of a cutting mechanism of a roll, a serrated edge, a knife, or scissors. FIGS. 2 and 4 depict second nonadhesive radial finger grip 12B abuts 15 perforated edge 11A. When length of material 2 is torn by a user at perforated edge 11A, second nonadhesive radial finger grip 12B is exposed for subsequent use.

FIG. 2 also illustrates novel tape 1 having length of material 2 in which second portion of nonadhesive track 7B has nonadhesive radial finger grip 12B. Second portion of nonadhesive track 7B has first edge 9B located next to first adhesive portion 6B. Second portion of nonadhesive track 7B has second edge 10B located next to second adhesive portion 8B. Second portion of nonadhesive track 7B has primary end 18B located opposite secondary end 19B. Second portion of nonadhesive track 7B is connected to 16 nonadhesive radial finger grip 12B at primary end 18B of second portion of nonadhesive track 7B. Nonadhesive radial finger grip 12B has first radial edge 13B bordering at least a portion of first adhesive portion 6B. Nonadhesive radial finger grip 12B has second radial edge 14B bordering at least a portion of second adhesive portion 8B. Third nonadhesive radial finger grip 12C abuts 15 perforated edge 11B. When length of material 1 is torn by a user at perforated edge 11B, third nonadhesive radial finger grip 12C is exposed for subsequent use.

FIG. 2 also depicts novel tape 1 having length of material 2 in which third portion of nonadhesive track 7C has nonadhesive radial finger grip 12C. Third portion of nonadhesive track 7C has first edge 9C located next to first adhesive portion 6C. Third portion of nonadhesive track 7C has second edge 10C located next to second adhesive portion 8C. Third portion of nonadhesive track 7C has primary end 18C located opposite secondary end 19C. Third portion of nonadhesive track 7C is connected to 16 nonadhesive radial finger grip 12C at primary end 18C of third portion of nonadhesive track 7C. Nonadhesive radial finger grip 12C has first radial edge 13C bordering at least a portion of first adhesive portion 6C. Nonadhesive radial finger grip 12C has second radial edge 14C bordering at least a portion of second adhesive portion 8C. The plurality of nonadhesive tracks 7A, 7B, and 7C are located one after the other in an orientation configured to reveal at least a portion of each subsequent nonadhesive track 7 portion during use.

FIG. 3 illustrates novel tape 1 having length of material 2 on roll 3 (FIGS. 3-4). Length of material 2 can have surface indicia 20 located at predetermined lengths of the length of material 2. For example, surface indicia 20 could be a dashed line visually indicating to a user that tape 1 is of a 2 inch length and is a desired length to be cut. Surface indicia 20 can be a cutting indicator that can be of a certain measurement such as including, but not limited to, 1 inch, two inch, or three inch lengths of material 2. At least one surface indicia 20 or a plurality of surface indicia 20 can be oriented at a predetermined length along length of material 2. Surface indicia 20 allows length of material 2 to be torn or separated from a subsequent portion of length of material 2 at a predetermined or specified measurement interval. Second nonadhesive radial finger grip 12B abuts 21 surface indicia 20. When length of material 2 is torn by a user at surface indicia 20, second nonadhesive radial finger grip 12B is exposed for subsequent use. Second portion of nonadhesive track 7B has nonadhesive radial finger grip 12B. Second portion of nonadhesive track 7B has first edge 9B located next to first adhesive portion 6B. Second portion of nonadhesive track 7B has second edge 10B located next to second adhesive portion 8B. Subsequent nonadhesive radial finger grips 12C and 12D are seen to abut surface indicia 20 on roll 3.

It will be seen that the advantages set forth above, and those made apparent from the foregoing description, are efficiently attained and since certain changes may be made in the above construction without departing from the scope of this invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

1. Packaging tape having a nonadhesive portion, comprising:
packaging tape, said packaging tape being a length of material, said length of material having a first side located opposite a second side;
said second side of said length of material having a nonadhesive track, said nonadhesive track having a first edge located opposite a second edge, said nonadhesive track having a first end located opposite a second end, said nonadhesive track traverses said length of material;
said second side of said length of material having a first adhesive portion abutting said first edge of said nonadhesive track; and,
said second side of said length of material having a second adhesive portion abutting said second edge of said nonadhesive track.

2. The packaging tape of claim 1, wherein said length of material is formed on a roll.

3. The packaging tape of claim 1, wherein said first edge of said nonadhesive track and said second edge of said nonadhesive track traverse said length of material.

4. The packaging tape of claim 1, wherein said length of material having a nonadhesive radial finger grip configured to receive a finger of a user, said nonadhesive radial finger grip having a first radial edge bordering said first adhesive portion of said length of material, said nonadhesive radial finger grip having a second radial edge bordering said second adhesive portion of said length of material, said first end of said nonadhesive track is connected to said nonadhesive radial finger grip.

5. The packaging tape of claim 4, wherein at least a portion of said nonadhesive radial finger grip abuts a first perforated leading edge of said length of material, said nonadhesive radial finger grip is located between said first perforated leading edge of said length of material and said nonadhesive track.

6. The packaging tape of claim 5, wherein said first perforated leading edge of said length of material is oriented perpendicular to said nonadhesive track.

7. The packaging tape of claim 5, wherein said second end of said nonadhesive track is connected to a second perforated leading edge of said length of material, said nonadhesive track is oriented between said first perforated leading edge of said length of material and said second perforated leading edge of said length of material.

8. The packaging tape of claim 1, wherein said length of material having a series of perforations oriented perpendicular to said nonadhesive track.

9. The packaging tape of claim 8, wherein said nonadhesive track is oriented between said first perforated leading edge of said length of material and said second perforated leading edge of said length of material.

10. The packaging tape of claim 4, wherein at least a portion of said nonadhesive radial finger grip abuts a first surface indicia of said length of material, said nonadhesive radial finger grip is located between said first surface indicia of said length of material and said nonadhesive track.

11. The packaging tape of claim 10, wherein said second end of said nonadhesive track is connected to a second surface indicia of said length of material, said nonadhesive track is oriented between said first surface indicia of said length of material and said second surface indicia of said length of material, said first surface indicia and said second surface indicia are predetermined indicators configured to indicate to a user the portion of the length of material at which a user aligns a subsequent nonadhesive radial finger grip.

12. Packaging tape having a nonadhesive portion, comprising:
packaging tape, said packaging tape being a length of material, said length of material having a first side located opposite a second side;
said second side of said length of material having a nonadhesive track, said nonadhesive track having a first edge located opposite a second edge, said nonadhesive track having a first end located opposite a second end, said nonadhesive track traverses said length of material;
said second side of said length of material having a first adhesive portion abutting said first edge of said nonadhesive track;
said second side of said length of material having a second adhesive portion abutting said second edge of said nonadhesive track;
said length of material having a nonadhesive radial finger grip configured to receive a finger of a user, said nonadhesive radial finger grip having a first radial edge bordering said first adhesive portion of said length of material, said nonadhesive radial finger grip having a second radial edge bordering said second adhesive portion of said length of material, said first end of said nonadhesive track is connected to said nonadhesive radial finger grip;
at least a portion of said nonadhesive radial finger grip abuts a first surface indicia of said length of material, said nonadhesive radial finger grip is located between said first surface indicia of said length of material and said nonadhesive track;
said second end of said nonadhesive track is connected to a second surface indicia of said length of material, said nonadhesive track is oriented between said first surface indicia of said length of material and said second surface indicia of said length of material, said first surface indicia and said second surface indicia are predetermined indicators configured to indicate to a user the portion of the length of material at which a user aligns a subsequent nonadhesive radial finger grip; and,
said first radial edge and said second radial edge of said nonadhesive radial finger grip have a width extending beyond said first edge and said second edge of said nonadhesive track.

13. The packaging tape of claim 12, wherein said length of material is formed on a roll.

14. The packaging tape of claim 12, wherein said first edge of said nonadhesive track and said second edge of said nonadhesive track traverse said length of material.
